(19) United States
(12) Patent Application Publication
(10) Pub. No.: US 2019/0289474 A1
(43) Pub. Date: Sep. 19, 2019

(54) COMMUNICATION DEVICE AND SCHEDULE CREATION METHOD

(71) Applicants: DENSO TEN Limited, Kobe-shi (JP); SUBARU CORPORATION, Tokyo (JP)

(72) Inventors: Yukisuke OZAKI, Kobe-shi (JP); Yoshitaka HIRASHIMA, Kobe-shi (JP); Shizuka TAMURA, Kobe-shi (JP); Tomofumi SODA, Kobe-shi (JP); Satoru IKEDA, Kobe-shi (JP); Mitsuru SASAKI, Kobe-shi (JP); Tsuyoshi KANEKO, Kobe-shi (JP); Hiroshi NOMOTO, Tokyo (JP)

(73) Assignees: DENSO TEN Limited, Kobe-shi (JP); SUBARU CORPORATION, Tokyo (JP)

(21) Appl. No.: 16/286,845

(22) Filed: Feb. 27, 2019

(30) Foreign Application Priority Data
Mar. 16, 2018 (JP) 2018-050183

(51) Int. Cl. H04W 16/22; G07C 5/00; H04W 72/12; H04W 4/40; H04W 64/00; G06F 11/30; G06N 20/00

(52) U.S. Cl. CPC H04W 16/22; G07C 5/008; H04W 72/1242; G06N 20/00; H04W 64/006; G06F 11/3072; H04W 4/40

(57) ABSTRACT

A communication device according to an embodiment includes a prediction unit and a creation unit. The prediction unit predicts a transition of a communication quality in each communication area. The creation unit creates a communication schedule of data communication for a terminal device based on the transition of a communication quality in each communication area that is predicted by the prediction unit and a state of the terminal device that is predicted from schedule information that relates to a schedule of the terminal device.

### CROSS-REFERENCE TO RELATED APPLICATION

This application is based upon, and claims the benefit of priority to, Japanese Patent Application No. 2018-050183 filed on Mar. 16, 2018, the entire contents of which are herein incorporated by reference.

### FIELD

An aspect of an embodiment relates to a communication device and a schedule creation method.

### BACKGROUND

Conventionally, there is, for example, a communication device that collects particular data from a terminal device such as a navigation device of a vehicle. In such a communication device, scheduling of data communication is executed for each terminal device based on a predicted communication quality, so that an increase in communication traffic is prevented (see, for example, Japanese Patent Application Publication No. 2008-199381).

However, in a conventional technique, there is room for improvement in that a suitable communication schedule is created. Specifically, in a conventional technique, while a schedule is created in such a manner that a terminal device executes uploading in a time zone with a good communication quality, whether or not a terminal device in a time zone to execute uploading is provided in a state where it is possible to execute communication is not considered.

### SUMMARY

According to an aspect of an embodiment, a communication device includes a prediction unit that predicts a transition of a communication quality in each communication area, and a creation unit that creates a communication schedule of data communication for a terminal device based on the transition of a communication quality in each communication area that is predicted by the prediction unit and a state of the terminal device that is predicted from schedule information that relates to a schedule of the terminal device.

### BRIEF DESCRIPTION OF DRAWINGS

FIG. 1A is a diagram illustrating an outline of a schedule creation method.

FIG. 1B is a diagram illustrating an outline of a communication system.

FIG. 2 is a block diagram of an on-vehicle device.

FIG. 3 is a block diagram of a communication device.

FIG. 4 is a diagram illustrating a specific example of a transition of a communication quality.

FIG. 5 is a diagram illustrating a specific example of a trend of utilization.

FIG. 6 is a diagram illustrating a specific example of a priority for a data item.

FIG. 7 is a diagram illustrating a specific example of a communication schedule.

FIG. 8 is a diagram illustrating a specific example of rescheduling.

FIG. 9 is a flowchart illustrating steps of a process that is executed by a communication device.

FIG. 10 is a flowchart illustrating steps of a process that is executed by an on-vehicle device.

### DESCRIPTION OF EMBODIMENT

Hereinafter, a communication device and a schedule creation method according to an embodiment will be explained in detail with reference to the accompanying drawings. Additionally, this invention is not limited in the present embodiment.

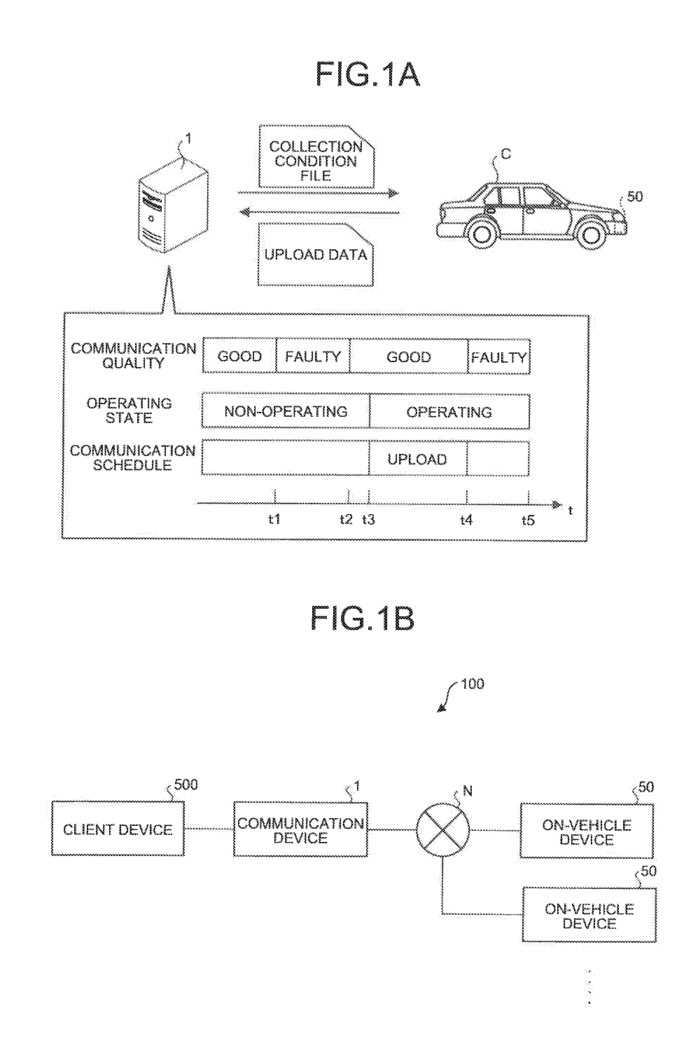

First, an outline of a schedule creation method according to an embodiment will be explained by using FIG. 1A. FIG. 1A is a diagram illustrating an outline of a schedule creation method. Additionally, a case where a terminal device is an on-vehicle device 50 that is mounted on a vehicle C will be provided as an example and explained in the present embodiment.

Furthermore, a schedule creation method according to an embodiment is executed by a communication device 1 as illustrated in FIG. 1A. The communication device 1 is, for example, a server device that collects running data of a vehicle C, infrastructure data around the vehicle C, or the like from the on-vehicle device 50.

The communication device 1 analyzes or processes data that are collected from the on-vehicle device 50 to add an additional value thereto and provide them to a client. For example, the communication device 1 creates a collection condition file where a data item that is a target of collection is specified according to a request of a client, and transmits it to the on-vehicle device 50.

Then, the on-vehicle device 50 uploads data that are matched with such a collection condition file onto the communication device 1. However, it may be impossible to execute uploading on the communication device 1 at timing when the on-vehicle device 50 acquires data that are a target of collection.

Specifically, it may take time to transmit uploading of data or the number of times to retry uploading may be increased by a time-out error, as a communication quality in a communication area where the on-vehicle device 50 is present is low.

Hence, a conventional technique may predict a transition of a communication quality and create a communication schedule of an on-vehicle device based on such a transition of a communication quality. However, in a conventional technique, an operating state of an on-vehicle device is not considered.

For example, in a conventional technique, a communication schedule may be created in such a manner that uploading is executed in a period of time when a power source of an on-vehicle device is turned off in a time zone with a good communication quality, that is, an on-vehicle is provided in a state where it is impossible to execute communication.

Hence, in a schedule creation method according to an embodiment, a communication schedule of the on-vehicle device 50 is created based on an operating situation of the on-vehicle device 50 in addition to a transition of a communication quality.

Specifically, in a schedule creation method according to an embodiment, each of a communication quality and an operating situation of the on-vehicle device 50 is predicted to create a communication schedule as illustrated in FIG. 1A.

An example as illustrated in FIG. 1A illustrates that a communication quality is presented as a good one or a faulty one, and in a case where a good one is provided, an amount of communication traffic is low, so that it is possible for the on-vehicle device 50 to execute uploading of data suitably. Furthermore, it illustrates that, in a case where a communication quality is faulty, an amount of communication traffic is high, so that it is difficult for the on-vehicle device 50 to execute uploading of data suitably.

Furthermore, in an operating situation as illustrated in FIG. 1A, OPERATING indicates a state where the on-vehicle device 50 is operated, that is, a power source thereof is turned on, while NON-OPERATING indicates a state where the on-vehicle device 50 is not operated, that is, a power source thereof is turned off. In other words, OPERATING indicates that an ignition switch of a vehicle C is turned on while NON-OPERATING indicates that the ignition switch of a vehicle C is turned off.

In a schedule creation method according to an embodiment, an operating situation of the on-vehicle device 50 is predicted based on schedule information that relates to a schedule of the on-vehicle device 50. Such schedule information includes a utilization history of a vehicle C, a goal that is set by the vehicle C, a schedule of a user of the vehicle C, or the like. Additionally, a detail of schedule information will be described later.

Subsequently, in a schedule creation method according to an embodiment, a communication schedule of the on-vehicle device 50 is created in such a manner that the on-vehicle device 50 uploads data at points of time t3 to t4 when it is predicted that a communication quality is good and the on-vehicle device 50 is operated.

Then, in a schedule creation method according to an embodiment, a collection condition file that includes such communication schedule is created and transmitted to the on-vehicle device 50. Thereby, in a case where the on-vehicle device 50 acquires data that correspond to such a collection condition file, it is possible to create upload data and upload such upload data to a communication device 1 in a period of points of time t3 to t4.

That is, in a schedule creation method according to an embodiment, a communication schedule is created in such a manner that uploading is executed in a time zone when a good communication quality is provided and a vehicle C is operated.

Therefore, in a schedule creation method according to an embodiment, it is possible to optimize a communication schedule depending on an operating situation of the on-vehicle device 50 as well as a transition of a communication quality, so that it is possible to create a suitable communication schedule.

Next, a communication system 100 according to an embodiment will be explained by using FIG. 1B. FIG. 1B is a diagram illustrating an outline of the communication system 100. As illustrated in FIG. 1B, the communication system 100 includes a client device 500 in addition to the communication device 1 and the on-vehicle device 50 as described above.

The client device 500 is a device that is managed by a client (a customer from the viewpoint of the communication device 1) that utilizes data that are collected by the communication device 1. The client device 500 acquires data that are collected from each on-vehicle device 50 by the communication device 1 and provides a predetermined service based on such data.

For example, a manager of the client device 500 operates the client device 500, sets a desired data collection condition, and notifies the communication device 1 of such a collection condition.

Such a collection condition includes data to be collected, a condition of a vehicle that is a target of collection of data, a collection trigger that includes a collection starting and ending trigger patterns, a method for reduction of data, upload timing, or the like.

As the communication device 1 acquires a collection condition, first, selection of a vehicle C that collects data, that is, the on-vehicle device 50 is executed based on such a collection condition. Subsequently, the communication device 1 creates a communication schedule of each selected on-vehicle device 50 and transmits a collection condition file as described above to each on-vehicle device 50 through a network N.

In a case where each on-vehicle device 50 acquires data that correspond to such a collection condition file, such data are uploaded onto the communication device 1 through the network N according to a communication schedule.

Then, the client device 500 appropriately takes, from the communication device 1, data that are collected from each on-vehicle device 50 by the communication device 1 to provide a predetermined service based on such data.

Additionally, although a case where one client device 500 is provided is illustrated herein, a plurality of client devices 500 may be provided or such a client device 500 may be integrated with the communication device 1. Furthermore, the client device 500 may collect data directly from each on-vehicle device 50 according to a collection condition file that is created by the communication device 1.

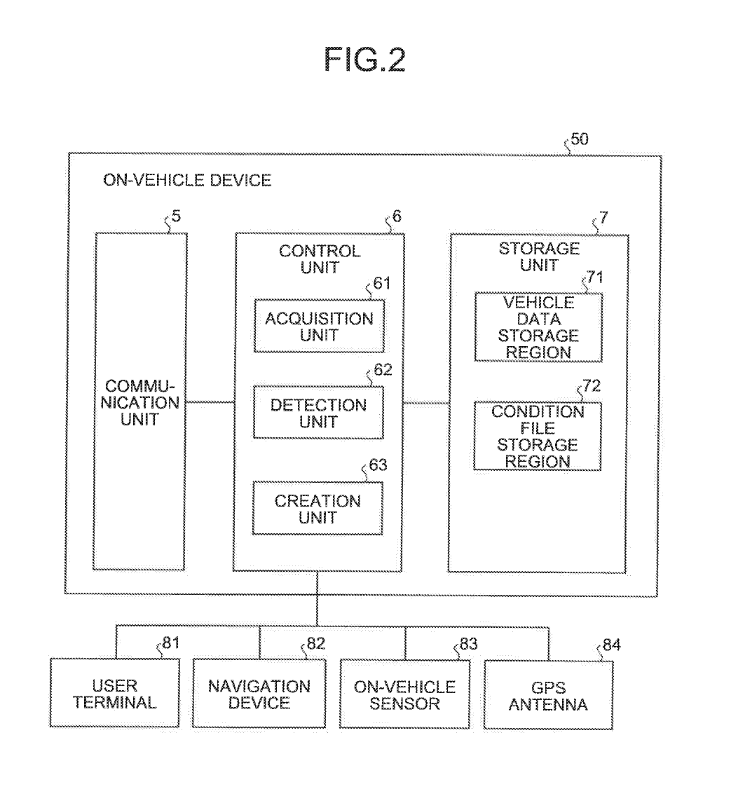

Next, a configuration example of the on-vehicle device 50 according to an embodiment will be explained by using FIG. 2. FIG. 2 is a block diagram of the on-vehicle device 50. As illustrated in FIG. 2, the on-vehicle device 50 is connected to a user terminal 81, a navigation device 82, an on-vehicle sensor 83, and a Global Positioning System (GPS) antenna 84.

The user terminal 81 includes, for example, a smartphone or tablet terminal that is possessed by a user of a vehicle C where it is possible to transmit or receive information by using, for example, the on-vehicle device 50 and a Near Field Communication or the like. For example, the user terminal 81 notifies the on-vehicle device 50 of schedule information of a user that is stored in the user terminal 81.

Schedule information is information that indicates a future schedule of a user and is set by a user in a calendar application or the like for the user terminal 81. For example, schedule information includes a starting time and an ending time of a schedule, information of a position where scheduling is executed, a content of a schedule, or the like.

Additionally, the on-vehicle device 50 may acquire schedule information from a cloud server that manages a schedule of a user on a cloud. Furthermore, the on-vehicle device 50 may acquire schedule information based on, for example, information that is registered in a variety of reservation websites for a restaurant, a hair salon, a concert, an airline ticket, a train, or the like.

The navigation device 82 notifies a user of a goal for a vehicle C or a route to the goal. Furthermore, in a case where a goal is set by a user, the navigation device 82 notifies the on-vehicle device 50 of goal information that includes the goal and a running route to the goal, a scheduled time of passage on each running route, or the like.

The on-vehicle sensor 83 is a sensor that detects running data of a vehicle C and outputs the detected running date to the on-vehicle device 50. For example, the on-vehicle sensor 83 includes a vehicle speed sensor that measures a vehicle speed of a vehicle C, a brake sensor that measures a brake situation of the vehicle C, a steering angle sensor that detects a steering angle of the vehicle C, or the like.

Additionally, an on-vehicle sensor may be a sensor that detects a water temperature or a hydraulic pressure of an engine, a sensor that detects a battery voltage of a vehicle C, an acceleration sensor that detects an acceleration of the vehicle C, or an occupant detection sensor that detects an occupant of the vehicle C.

Furthermore, the on-vehicle device 50 may be connected to a camera that captures an image of a surrounding of a vehicle C, a detection device that detects an obstacle around the vehicle C, or the like in addition to the on-vehicle sensor 83.

As for the rest, the on-vehicle device 50 may be connected to an electronic control instrument that executes electronic control of a vehicle C, a chassis system instrument, a body system instrument, a safety system instrument, or an entertainment system instrument. That is, it is possible for the on-vehicle device 50 to acquire every piece of information of a vehicle C.

In other words, in the communication system 100 according to an embodiment, the communication device 1 cooperates with the on-vehicle device 50 so that it is possible to collect a wide variety of information of a vehicle C. Additionally, an electronic control instrument as described above includes an engine control instrument, a transmission control instrument, or the like of a vehicle C and a chassis system instrument includes a steering control instrument or a suspension control instrument.

Furthermore, a body system instrument includes a door control instrument, an air conditioning control instrument, or a security control instrument, and a safety system instrument includes an air-bag control instrument, an automatic driving control instrument, or a driving support control instrument. Furthermore, an entertainment system instrument includes an AV instrument or the like. The GPS antenna 84 notifies the on-vehicle device 50 of position information that indicates a current location of a vehicle C.

The on-vehicle device 50 includes a communication unit 5, a control unit 6, and a storage unit 7. The communication unit 5 executes transmission or receipt of data with the communication device 1 through the network N as described above.

The control unit 6 includes an acquisition unit 61, a detection unit 62, and a creation unit 63. The acquisition unit 61 acquires vehicle data from the on-vehicle sensor 83 and stores them in a vehicle data storage region 71 of the storage unit 7. Furthermore, the acquisition unit 61 acquires a collection condition file from the communication device 1 through the communication unit 5 and stores it in a condition file storage region 72 of the storage unit 7.

The acquisition unit 61 acquires schedule information of a user from the user terminal 81, goal information that indicates a goal or the like of a vehicle C from the navigation device 82, or position information of the vehicle C from the GPS antenna 84, and appropriately transmit it to the communication device 1 through the communication unit 5.

The detection unit 62 detects vehicle data that are a target of collection from vehicle data that are stored in the vehicle data storage region 71. Specifically, the detection unit 62 detects vehicle data that correspond to a starting trigger and an ending trigger that are specified by a collection condition file that is stored in the condition file storage region 72, and detects vehicle data from such a starting trigger to such an ending trigger as vehicle data that are a target of collection.

Then, the detection unit 62 notifies the creation unit 63 of information regarding detected vehicle data that are a target of collection. The creation unit 63 creates upload data that are uploaded onto the communication device 1 regarding vehicle data that are a target of collection and are detected by the detection unit 62.

For example, the creation unit 63 causes an identifier, a point of time, position information, or the like for identifying a vehicle C to correspond to vehicle data and subsequently executes reduction according to a reduction method that is specified in a condition setting file as described above, so that upload data are created.

Then, the creation unit 63 uploads upload data onto the communication device 1 through the network N (see FIG. 1B) at timing that is specified by a communication schedule.

Herein, a reduction method in the present embodiment indicates, for example, decimating vehicle data. For example, in a case where the on-vehicle device 50 uploads position information of a vehicle C, position information of each intersection is uploaded and such position information of each intersection is put together by the communication device 1, so that it is possible to restore a running route where the vehicle C runs actually.

Furthermore, for another reduction method, a data difference may be uploaded only in a case where there is a change in data. In such a case, the communication device 1 adds a current difference to a previous value, so that it is possible to restore original data.

That is, the on-vehicle device 50 decimates and uploads vehicle data according to a reduction method, so that it is possible to reduce communication traffic. Then, the communication device 1 restores vehicle data according to a reduction method, so that it is possible to reduce communication traffic and collect vehicle data suitably.

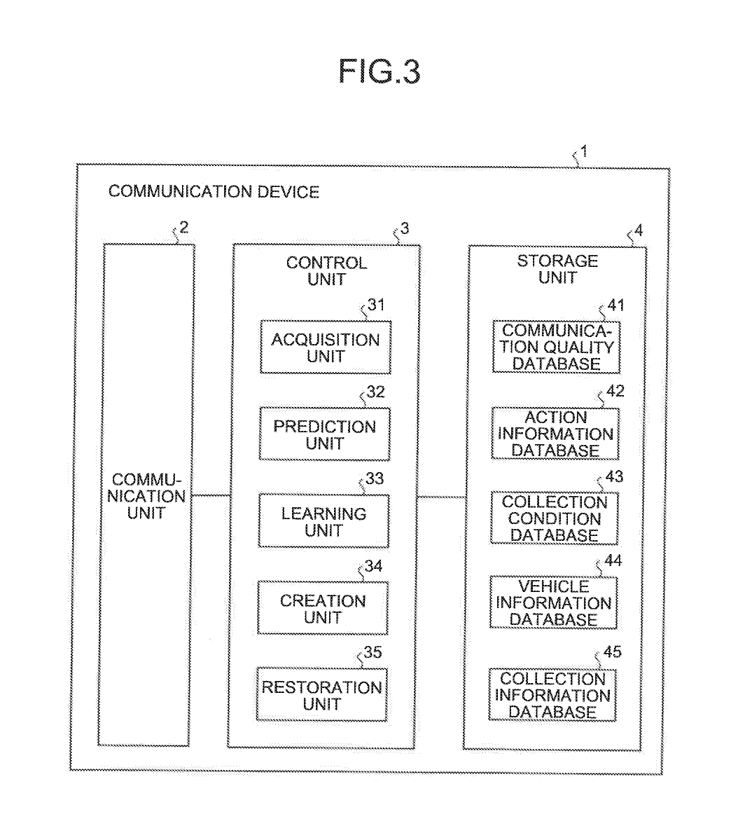

Next, a configuration example of the communication device 1 according to an embodiment will be explained by using FIG. 3. FIG. 3 is a block diagram of the communication device 1. As illustrated in FIG. 3, the communication device 1 includes a communication unit 2, a control unit 3, and a storage unit 4. The communication unit 2 is connected to the network N as described above and executes transmission or receipt of data with each on-vehicle device 50. Furthermore, it is also possible for the communication unit 2 to transmit or receive information with the client device 500.

The control unit 3 includes an acquisition unit 31, a prediction unit 32, a learning unit 33, a creation unit 34, and a restoration unit 35. The control unit 3 includes, for example, a computer that has a Central Processing Unit (CPU), a Read Only Memory (ROM), a Random Access Memory (RAM), a Hard Disk Drive (HDD), an input/output port, and the like, and a variety of circuits.

A CPU of a computer reads and executes, for example, a program that is stored in a ROM, and thereby, functions as the acquisition unit 31, the prediction unit 32, the learning unit 33, the creation unit 34, and the restoration unit 35 of the control unit 3.

Furthermore, it is also possible to compose at least one or all of the acquisition unit 31, the prediction unit 32, the learning unit 33, the creation unit 34, and the restoration unit 35 of the control unit 3 of hardware such as an Application Specific Integrated Circuit (ASIC) or a Field Programmable Gate Array (FPGA).

Furthermore, the storage unit 4 corresponds to, for example, a RAM or an HDD. It is possible for a RAM or an HDD to store a communication quality database 41, an action information database 42, a collection condition database 43, a vehicle information database 44, and a collection information database 45, and information such as a variety of programs. Additionally, the communication device 1 may acquire a program or a variety of information as described above through another computer that is connected by a wired or wireless network or a portable recording medium.

The acquisition unit 31 of the control unit 3 acquires a variety of information from the on-vehicle device 50 or the client device 500. For example, the acquisition unit 31 acquires from the on-vehicle device 50, and stores in the action information database 42, position information of a vehicle C or goal information, schedule information, or the like as described above.

Furthermore, the acquisition unit 31 acquires upload data from the on-vehicle device 50 and outputs such upload data to the restoration unit 35. Furthermore, the acquisition unit 31 acquires a collection condition from the client device 500 as described above and stores such a collection condition in the collection condition database 43.

The prediction unit 32 predicts a transition of a communication quality in each communication area and stores the predicted transition of a communication quality in each communication area in the communication quality database 41 of the storage unit 4.

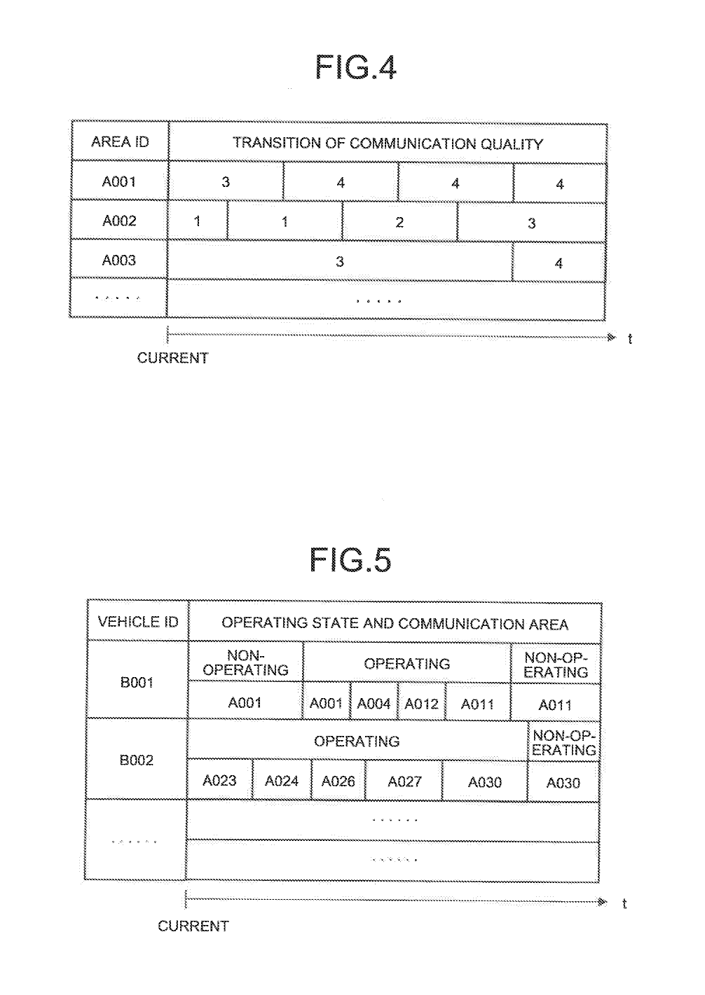

FIG. 4 is a diagram illustrating a specific example of a transition of a communication quality that corresponds to a specific example of information that is stored in the communication quality database 41. As illustrated in FIG. 4, for example, an area ID and a transition of a communication quality are caused to correspond thereto and stored in the communication quality database 41.

An area ID as illustrated in FIG. 4 is an identifier for identifying each communication area and a transition of a communication quality indicates a transition of a communication quality in each communication area that is predicted by the prediction unit 32.

It is possible for the prediction unit 32 to predict a future transition of a communication quality in each communication area from a past transition of the communication quality. For example, the prediction unit 32 first predicts a transition of the number of vehicles C in each communication area or a transition of communication traffic that is used by each vehicle C, based on a trend of utilization of the on-vehicle device 50 (vehicle C) that is provided by the learning unit 33 as described later.

That is, the prediction unit 32 predicts a transition of communication traffic that is uploaded in each communication area, based on a distribution of respective vehicles C or expected communication traffic of each vehicle C. Subsequently, the prediction unit 32 subtracts a transition of communication traffic as described above from an upper limit of communication traffic that is communicable per unit time in each communication area to predict a transition of a communication quality.

In an example as illustrated in FIG. 4, a communication quality is represented by four levels of “1” to “4” where a larger number indicates a better communication quality. Additionally, although a communication quality is herein represented by four levels, such a communication quality may be three or less levels or may be five or greater levels.

By returning to an explanation of FIG. 3, the learning unit 33 will be explained. The learning unit 33 learns a trend of use of the on-vehicle device 50 based on a utilization history that includes a history of position information of the on-vehicle device 50. Then, the learning unit 33 stores a result of learning in the action information database 42 of the storage unit 4.

The learning unit 33 analyzes, for example, a position where a vehicle C is stopped, a route from a position of a stopped vehicle to a goal, or the like, from a utilization history as described above, to learn a trend of use of the vehicle C.

That is, the learning unit 33 analyzes a pattern such as a time zone where a vehicle C is used or an area where the vehicle C runs for each of such time zones, from a utilization history. Furthermore, a utilization history includes an item such as a point of time, a day of week, weather, or presence or absence of an event.

That is, it is also possible for the learning unit 33 to analyze a trend of use of a vehicle C for each item such as a point of time, a day of week, weather, or presence or absence of an event. Additionally, presence or absence of an event refers to, for example, presence or absence of an accident, presence or absence of a traffic regulation, presence or absence of a traffic jam, or presence or absence of an event or a festival that is held near an area where a vehicle C runs. It is possible for the communication device 1 to acquire such event information from a non-illustrated external server appropriately.

Furthermore, the learning unit 33 may acquire information regarding a driver or a passenger of a vehicle C and learn a trend of utilization for each driver or each combination of such a driver and such a passenger. It is possible for the learning unit 33 to link a driver or a passenger to a goal for a vehicle C or timing of taking such a vehicle to execute learning.

Additionally, for example, an image that is captured by a (non-illustrated) in-vehicle camera that is placed in a vehicle C is analyzed by the on-vehicle device 50 or the communication device 1 so that it is possible to acquire information regarding a driver or a passenger.

FIG. 5 is a diagram illustrating a specific example of a trend of utilization that corresponds to a specific example of information that is stored in the action information database 42. As illustrated in FIG. 5, a vehicle ID and a set of an operating situation and a communication area are caused to correspond thereto and stored in the action information database 42.

A vehicle ID as illustrated in FIG. 5 is an identifier for identifying a vehicle C, that is, the on-vehicle device 50. Furthermore, an operating situation and a communication area indicate an operating situation of a vehicle C, that is, an on/off state of an ignition switch of the vehicle C and a communication area where the vehicle C is located.

In an example as illustrated in FIG. 5, a case where an operating situation is NON-OPERATING indicates that a vehicle C is stopped, that is, an ignition switch of the vehicle C is turned off and a power source of the on-vehicle device 50 is turned off.

Furthermore, as illustrated in FIG. 5, although a communication area is changed in a case where an operating situation is OPERATING, this indicates that a vehicle C moves across a communication area.

By returning to an explanation of FIG. 3, the creation unit 34 will be explained. The creation unit 34 creates a communication schedule of data communication of such an on-vehicle device 50 based on a transition of a communication quality in each communication area that is predicted by the prediction unit 32 and a state of the on-vehicle device 50 that is predicted from schedule information that relates to a schedule of the on-vehicle device 50.

As the creation unit 34 creates a communication schedule, a collection condition file where a vehicle ID, an address, a method for reducing data, or the like is cased to correspond to a communication schedule is created and transmitted to each on-vehicle device 50 through the communication unit 2 and the network N.

First, the creation unit 34 selects, from the vehicle information database 44, the on-vehicle device 50 that is a target of collection that is specified by a collection condition that is acquired from the client device 500 as illustrated in FIG. 1B.

For example, user information that relates to a user of each on-vehicle device 50 or vehicle information that includes vehicle type information or the like of a vehicle C is stored in the vehicle information database 44. Furthermore, user information includes an age, a gender, an address, a career or the like of a user.

For example, vehicle information is registered in the vehicle information database 44 by a dealer at a time of purchase of the on-vehicle device 50. Alternatively, a user may register vehicle information in the vehicle information database 44 through the Internet.

Subsequently, the creation unit 34 reads a trend of utilization of the selected on-vehicle device 50 from the action information database 42. That is, the creation unit 34 creates a communication schedule based on a trend of utilization that is learned by the learning unit 33.

In other words, the communication device 1 according to an embodiment stores a utilization history of the on-vehicle device 50, so that it is possible to derive a behavior pattern of a user of a vehicle C accurately, and a communication schedule is created based on such a behavior pattern, so that it is possible to create a suitable communication schedule.

Herein, in a case where goal information or schedule information of such an on-vehicle device 50 is acquired, the creation unit 34 reads the goal information or the schedule information together therewith.

Then, the creation unit 34 creates a communication schedule by using goal information or schedule information. For example, in a case where a goal is set in the navigation device 82 (see FIG. 2) of a vehicle C, a probability that the vehicle C travels to such a goal thereafter is high. Furthermore, in a case where a schedule of a user is set in the user terminal 81, a possibility that the user executes such a schedule is high.

That is, the creation unit 34 utilizes goal information or schedule information, so that it is possible to create a communication schedule based on a schedule of the on-vehicle device 50 with high reliability. In other words, goal information or schedule information is utilized, so that it is possible to suitably specify timing when the on-vehicle device 50 executes uploading.

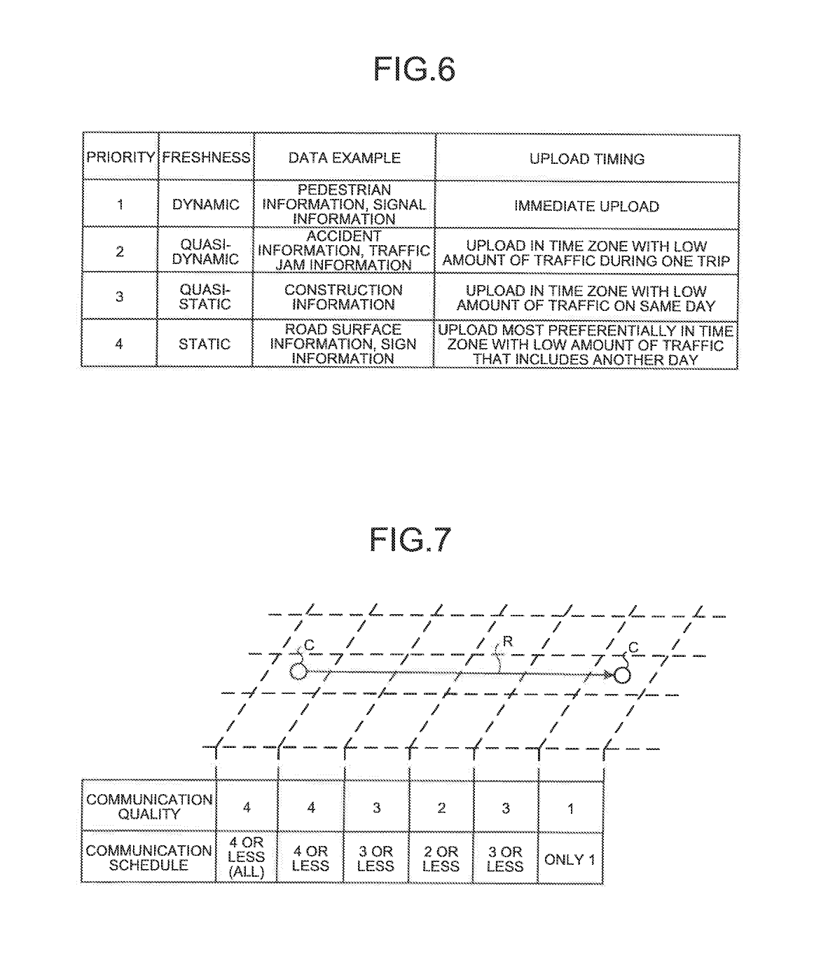

Furthermore, the creation unit 34 provides a priority to each data item to be collected, with reference to the collection condition database 43, and creates a communication schedule. FIG. 6 is a diagram illustrating a specific example of a priority for a data item.

As illustrated in FIG. 6, in the communication system 100, a priority is provided to each data item to be collected. In an example as illustrated in FIG. 6, a priority is represented by four levels of “1” to “4” where a smaller number indicates a higher priority.

Furthermore, in a case where freshness of information is needed, in other words, a case where a state of data is changed with every moment, a priority is set to be high, or in a case where freshness of information is not needed, a priority is set to be low.

Specifically, a priority for pedestrian information or signal information is set to be high. Pedestrian information is information that relates to a pedestrian around a vehicle C and signal information indicates a color of a signal where a vehicle C passes therethrough, that is, a state of such a signal.

Freshness of pedestrian information or signal information is needed, so that a priority thereof is set at “1” that is highest and a communication schedule is created so as to execute uploading immediately.

Furthermore, information freshness of accident information or traffic jam information is less needed than that of pedestrian information or signal information, so that a priority thereof is set at “2” that is second highest and a communication schedule is created so as to execute uploading, for example, in a time zone with a low amount of traffic during one trip of a vehicle C.

Furthermore, information freshness of construction information is even less needed, so that a priority thereof is set at “3” and a communication schedule is created so as to execute uploading in a time zone with a low amount of traffic on the same day.

Then, a state of road surface information or sign information is nearly unchanged, so that information freshness thereof is not needed. Hence, a priority of “4” that is lowest is set for road surface information or sign information and a communication schedule is created so as to execute uploading, most preferentially, in a time zone with a low amount of traffic that includes another day.

FIG. 7 is a diagram illustrating a specific example of a communication schedule. FIG. 7 represents a vehicle C by “0” and a running route R as illustrated in FIG. 7 indicates a route that is predicted in such a manner that a vehicle C runs thereon from now. As described above, a running route R is predicted based on a trend of utilization that is learned by the learning unit 33, goal information, schedule information, or the like.

Furthermore, a case where the creation unit 34 creates a communication schedule of the on-vehicle device 50 that is mounted on a vehicle C (that is not illustrated herein) in a case where the vehicle C runs across a plurality of communication areas (regions that are enclosed by broken lines) will be explained herein.

In such a case, the creation unit 34 reads a communication quality at a schedule time of passage of a vehicle C through each communication area, from the communication quality database 41, and creates a communication schedule based on such a communication quality.

Specifically, the creation unit 34 creates a communication schedule in such a manner that a priority (see FIG. 6) in a time zone when passage through a communication area where a communication quality is “4” that is best is scheduled is 4 or less, that is, all data are uploaded.

Furthermore, the creation unit 34 creates a communication schedule in such a manner that data with a priority that is “3” or less are uploaded in a time zone when passage through a communication area where a communication quality is “3” is scheduled and data with a priority that is “2” or less are uploaded in a time zone when passage through a communication area where a communication quality is “2” is scheduled.

Then, a communication schedule is created in such a manner that only data that correspond to a priority of “1” that is highest are uploaded in a time zone when passage through a communication area where a communication quality is “1” that is worst is scheduled.

Thus, it is possible for the creation unit 34 to optimize a communication schedule according to a communication quality on a running route R where a vehicle C runs. Meanwhile, only data that correspond to a priority of “1” that is highest are uploaded for a period of time when a communication quality is “1”.

Hence, in a case where the on-vehicle device 50 acquires data that correspond to a priority other than “1” for such a period of time, such data are not uploaded. Furthermore, a case is also expected where the on-vehicle device 50 tries to upload data but an actual communication quality is so low that it is not possible to execute uploading thereof.

Hence, the on-vehicle device 50 transmits a request for rescheduling of timing when such data are uploaded and the creation unit 34 executes creation of a communication schedule again based on such a request for rescheduling.

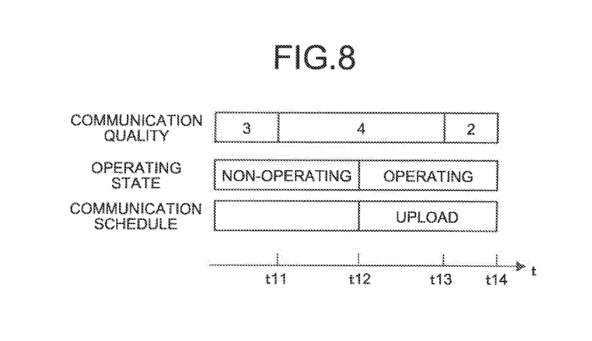

FIG. 8 is a diagram illustrating a specific example of rescheduling. As illustrated in FIG. 8, in such a case, the creation unit 34 creates a communication schedule in such a manner that uploading is executed at points of time t12 to t13 that are a time zone when the on-vehicle device 50 is provided in an operating state and a communication quality is “4” that is good.

Herein, a communication schedule is created in such a manner that data are uploaded in descending order of priority for a period of time that is points of time t12 to t13 when a communication quality is “4” that is best and data that are not capable of being uploaded for such a period of time are uploaded for a period of time that is points of time t13 to t14.

Then, a communication schedule is created in such a manner that data that are not capable of being uploaded for a period of time that is points of time t13 to t14 are uploaded, next time, in a time zone when a communication quality is good and the on-vehicle device 50 is estimated to operate.

That is, the creation unit 34 creates a communication schedule in such a manner that data with a high priority are uploaded preferentially and data with a low priority are uploaded later.

Additionally, as described above, a priority of data is high in a case where freshness of data is needed. That is, a value of data with a high priority is decreased with a passage of time. Hence, the creation unit 34 may create a communication schedule on a condition that, in a case where it is not possible to upload data with a high priority according to an initial communication schedule, such data are not uploaded.

By returning to an explanation of FIG. 3, the restoration unit 35 will be explained. The restoration unit 35 restores data that are uploaded from each on-vehicle device 50, according to a reduction method as described above, and stores the restored data in the collection information database 45 of the storage unit 4.

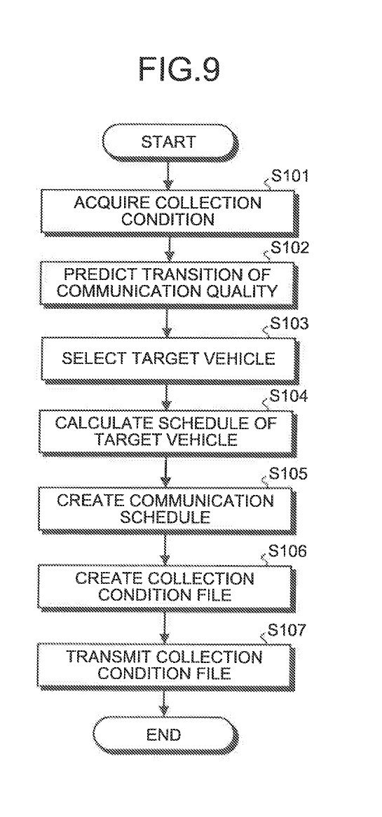

Next, steps of a process that is executed by the communication device 1 according to an embodiment will be explained by using FIG. 9. FIG. 9 is a flowchart illustrating steps of a process that is executed by the communication device 1.

As illustrated in FIG. 9, first, the acquisition unit 31 of the communication device 1 acquires a collection condition from the client device 500 (step S10). Subsequently, the prediction unit 32 predicts a transition of a communication quality in each communication area (step S102).

Subsequently, the creation unit 34 selects a target vehicle where data thereof are collected, based on a collection condition as described above (step S103) and calculates a schedule of such a target vehicle (step S104).

Subsequently, the creation unit 34 creates a communication schedule based on a transition of a communication quality and schedule information of a target vehicle (step S105) and creates a collection condition file (step S106). The creation unit 34 transmits the created collection condition file (step S107) and ends such a process.

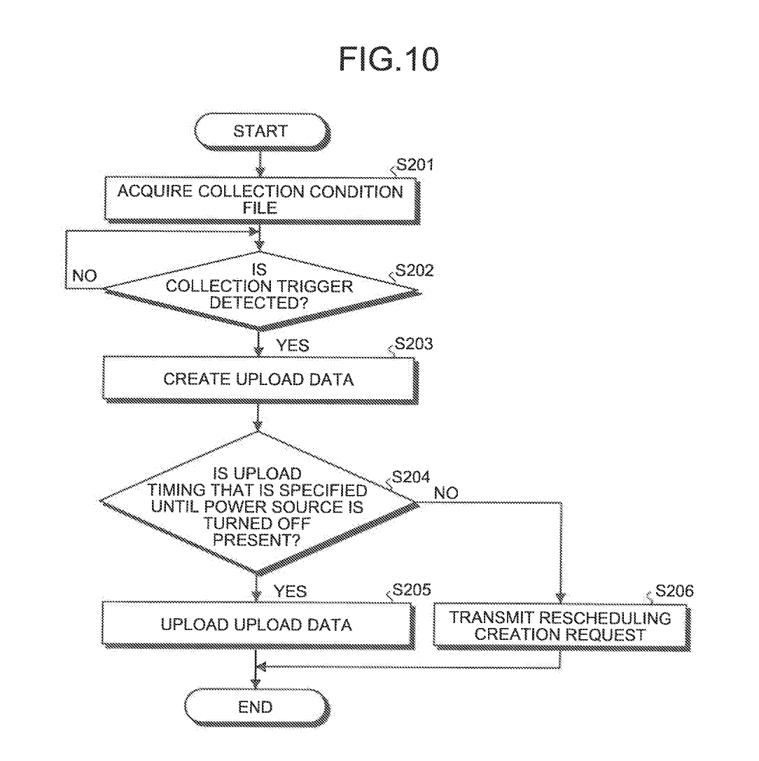

Next, steps of a process that is executed by the on-vehicle device 50 will be explained by using FIG. 10. FIG. 10 is a flowchart illustrating steps of a process that is executed by the on-vehicle device 50.

As illustrated in FIG. 10, first, the acquisition unit 61 of the on-vehicle device 50 acquires a collection condition file from the communication device 1 (step S201). Subsequently, the detection unit 62 determines whether or not a collection trigger is detected from vehicle data (step S202).

In a case where the detection unit 62 detects a collection trigger (step S202, Yes), the creation unit 63 creates upload data (step S203). On the other hand, in a case where the detection unit 62 does not detect a collection trigger (step S202, No), a process at step S202 is executed continuously.

Subsequently, the creation unit 63 determines whether or not upload timing that is specified before turning off of a power source is present (step S204). Then, in a case where upload timing is present (step S204, Yes), the creation unit 63 uploads upload data at such upload timing (step S205) and ends such a process.

Furthermore, in a case where upload timing is not present (step S204, No), the creation unit 63 transmits a rescheduling creation request to the communication device 1 (step S206) and ends such a process.

As described above, the communication device 1 according to an embodiment includes the prediction unit 32 and the creation unit 34. The prediction unit 32 predicts a transition of a communication quality in each communication area. The creation unit 34 creates a communication schedule of data communication for such an on-vehicle device 50 (an example of a terminal device) based on the transition of a communication quality in each communication area that is predicted by the prediction unit 32 and a state of such an on-vehicle device 50 that is predicted from schedule information that relates to a schedule of the on-vehicle device 50. Therefore, it is possible for the communication device 1 according to an embodiment to create a suitable communication schedule.

Meanwhile, although a case where the communication device 1 creates a communication schedule of data that are uploaded by the on-vehicle device 50 has been explained in an embodiment as described above, this is not limiting. That is, it is also possible for the communication device 1 to create a communication schedule of data that are downloaded by the on-vehicle device 50.

Furthermore, although a case where the communication device 1 creates a communication schedule based on a priority that is based on freshness of data has been explained in an embodiment as described above, this is not limiting. That is, such a priority may be a priority that is based on communication traffic for each data item or another priority. Furthermore, no priority may be provided.

Furthermore, although an operating state of a vehicle C is represented by operating or non-operating in an embodiment as described above, such an operating state may include charging. For example, in a case where a vehicle C is an electric vehicle, it is also possible to create a communication schedule in such a manner that data is transmitted during charging of such a vehicle C. That is, as long as charging of a vehicle C is executed, it is possible for the on-vehicle device 50 to transmit data without causing a battery to run out.

Furthermore, although a case where a terminal device is the on-vehicle device 50 has been explained in an embodiment as described above, such a terminal device may be a communication instrument such as a smartphone or a tablet terminal.

According to an aspect of an embodiment, it is possible to create a suitable communication schedule.

It is possible for a person skilled in the art to readily derive a further effect or variation example. Accordingly, a broader aspect of the present invention is not limited to a specific detail and a representative embodiment as illustrated and described above. Therefore, various modifications are possible without departing from the spirit or scope of a general inventive concept as defined by the appended claims and equivalents thereof.

What is claimed is:

1. A communication device, comprising:
a prediction unit that predicts a transition of a communication quality in each communication area; and
a creation unit that creates a communication schedule of data communication for a terminal device based on the transition of a communication quality in each communication area that is predicted by the prediction unit and a state of the terminal device that is predicted from schedule information that relates to a schedule of the terminal device.

2. The communication device according to claim 1, further comprising
a learning unit that learns a trend of utilization of the terminal device based on a utilization history that includes a history of position information of the terminal device, wherein
the creation unit creates the communication schedule while the trend of utilization that is learned by the learning unit is provided as the schedule information.

3. The communication device according to claim 1, wherein the creation unit creates the communication schedule while an action schedule of a user of the terminal device is provided as the schedule information.

4. The communication device according to claim 1, wherein the creation unit creates the communication schedule while a goal that is set as a destination for the terminal device and a route to the goal are provided as the schedule information.

5. The communication device according to claim 1, wherein the creation unit creates the communication schedule in such a manner that a priority that is based on freshness of data is provided to each data item of the data communication and the terminal device executes data communication preferentially for the data item with the priority that is high.

6. A schedule creation method, comprising:
predicting a transition of a communication quality in each communication area; and
creating a communication schedule of data communication for a terminal device based on the transition of a communication quality in each communication area that is predicted in the predicting and a state of the terminal device that is predicted from schedule information that relates to a schedule of the terminal device.
